(19) United States
(12) Patent Application Publication
(10) Pub. No.: US 2015/0145776 A1
(43) Pub. Date: May 28, 2015

(54) Information Input System, Portable Terminal Device, and Computer That Ensure Addition of Function

(71) Applicant: Kyocera Document Solutions Inc., Osaka (JP)

(72) Inventors: Hideki Takeda, Osaka (JP); Yoshihisa Tanaka, Osaka (JP)

(21) Appl. No.: 14/555,524

(22) Filed: Nov. 26, 2014

(30) Foreign Application Priority Data
Nov. 26, 2013 (JP) 2013-244388

(51) Int. Cl. G06F 3/0488; G06F 3/038; G06F 3/0485; G06F 3/0354

(52) U.S. Cl. CPC G06F 3/04886; G06F 3/03547; G06F 3/038; G06F 3/0485
USPC 345/158

(57) ABSTRACT

An information input system includes a computer and a portable terminal device. The portable terminal device includes: an image capturing unit; a detecting unit that detects a moving direction and an amount of movement of the portable terminal device based on a captured image, and a transmission controller that transmits movement information indicative of the moving direction and the amount of movement detected by the detecting unit to the computer. The computer includes: an information receiving unit that receives the movement information, the movement information being transmitted from the transmission controller of the portable terminal device; and an information accepting unit that accepts the moving direction and the amount of movement indicated by the movement information received by the information receiving unit as a moving direction and an amount of movement in which a cursor moves, the cursor functioning in an application program operated on the computer.

### INCORPORATION BY REFERENCE

This application is based upon, and claims the benefit of priority from, corresponding Japanese Patent Application No. 2013-244388 filed in the Japan Patent Office on Nov. 26, 2013, the entire contents of which are incorporated herein by reference.

### BACKGROUND

Unless otherwise indicated herein, the description in this section is not prior art to the claims in this application and is not admitted to be prior art by inclusion in this section.

To make a carrying convenient, many information processors whose constitutions, such as a keyboard, are minimized to achieve downsizing and lightweight have been proposed. The information processor having thus minimal functions is desired to improve its operability. Nowadays, to facilitate an operation of inputting information to a computer, there has been proposed various user interfaces. For example, there has been proposed the following apparatus. One portable terminal is connected to a personal computer so as to ensure mutual data exchange. Additionally, there has been proposed a device where a user interface displayed on a display of a personal computer is further improved. This improves operability of an operator.

### SUMMARY

An information input system according to one aspect of the disclosure includes a computer and a portable terminal device. The portable terminal device includes: an image capturing unit that captures an image of a facing object; a detecting unit that detects a moving direction and an amount of movement of the portable terminal device based on a captured image captured by the image capturing unit, and a transmission controller that transmits movement information indicative of the moving direction and the amount of movement detected by the detecting unit to the computer. The computer includes: an information receiving unit that receives the movement information, the movement information being transmitted from the transmission controller of the portable terminal device; and an information accepting unit that accepts the moving direction and the amount of movement indicated by the movement information received by the information receiving unit as a moving direction and an amount of movement in which a cursor moves, the cursor functioning in an application program operated on the computer.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an entire information input system according to one embodiment of the disclosure.

FIG. 2 schematically illustrates an internal constitution of a portable terminal device according to the one embodiment.

FIG. 3 schematically illustrates a constitution of a PC according to the one embodiment.

FIG. 4 illustrates a flow of processes of an information input process by a portable terminal device in an information input system according to a first embodiment.

FIG. 5 illustrates a flow of processes of an information input process by a PC in the information input system according to the first embodiment.

FIG. 6 illustrates an exemplary state where an image for accepting instruction is displayed on a display unit of the portable terminal device.

FIG. 7 illustrates a constitution of a portable terminal device according to a second embodiment.

FIG. 8 illustrates a flow of processes in an image capturing input process by an information input system that includes the portable terminal device and a PC according to the second embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an information input system, a portable terminal device, and a computer according to one embodiment of the disclosure with reference to the drawings.

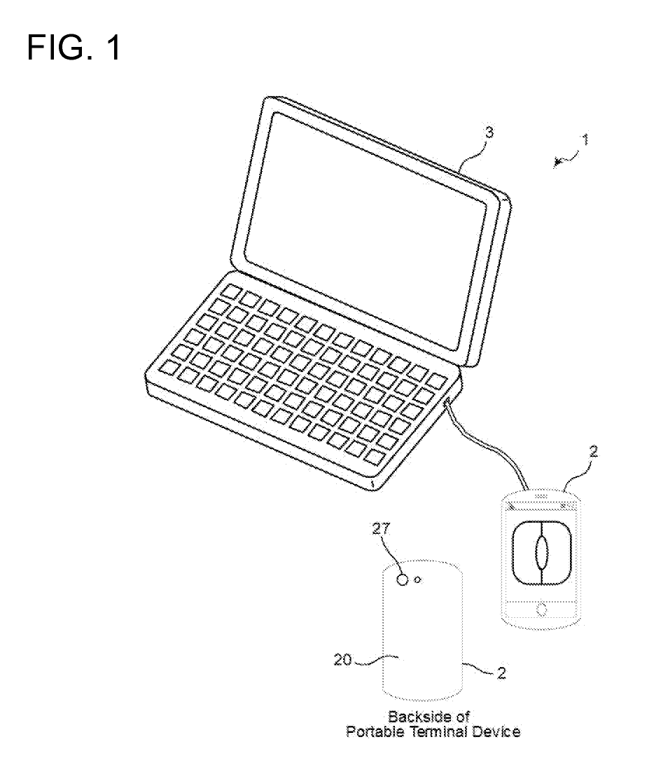

FIG. 1 illustrates an entire information input system 1. As illustrated in FIG. 1, the information input system 1 includes a portable terminal device 2 and a personal computer (hereinafter referred to as PC) 3. In the information input system 1, the portable terminal device 2 is connected to the PC 3. The portable terminal device 2 functions as a device that inputs a click operation, a scroll operation, a captured image, a similar operation, or image to the PC 3. The portable terminal device 2 may be connected to the PC 3 by any of wired connection using a USB cable or similar means and by wireless connection in Bluetooth (registered trademark) or a similar protocol.

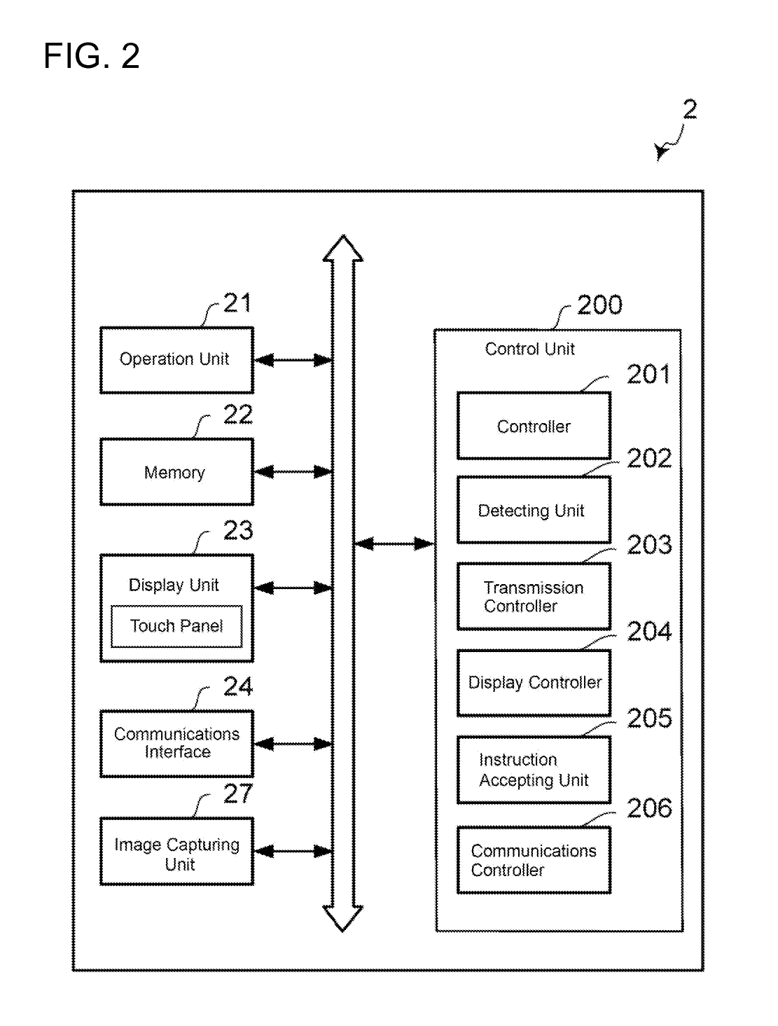

FIG. 2 is a block diagram schematically illustrating an internal constitution of the portable terminal device 2 according to a first embodiment. The portable terminal device 2 includes a control unit 200, an operation unit 21, a memory 22, a display unit 23, a communications interface 24, and an image capturing unit 27. These respective units can mutually exchange data or a signal via a CPU bus.

The control unit 200 is constituted of a CPU and similar members that include ROM and RAM. The control unit 200 manages an entire operation control of the portable terminal device 2.

The operation unit 21 is constituted of a numeric keypad as a hardware constitution, a touch panel located at the display unit 23, and a similar member. To the operation unit 21, for example, a click operation and a scroll operation are input via the touch panel. This touch panel functions as a contact position detector that detects a contact position at a display region of the display unit 23 by the operator.

The memory 22 stores image data displayed by the display unit 23 and various application programs. The memory 22 stores an information input program according to one embodiment of the disclosure.

When the control unit 200 operates in accordance with this information input program, the control unit 200 functions as a detecting unit 202, a transmission controller 203, a display controller 204, an instruction accepting unit 205, and a communications controller 206, which will be described later. However, the detecting unit 202, the transmission controller 203, the display controller 204, the instruction accepting unit 205, and the communications controller 206 of the control unit 200 may be constituted of respective hardware circuits independent of an operation based on the information input program. Hereinafter, unless otherwise stated especially, the same goes for the respective embodiments.

The display unit 23 is constituted of a Liquid Crystal Display (LCD) or a similar display. The display unit 23 displays an image and a message required to operate this portable terminal device 2. Additionally, the display unit 23 displays an image for accepting instruction. The image for accepting instruction is to accept an instruction by the operator through the click operation and the scroll operation. This image for accepting instruction includes, for example, an image for accepting right-click instruction and an image for accepting left-click instruction of a mouse pointer, and an image for accepting scroll instruction. The memory 22 stores these images for accepting instruction.

The communications interface 24 functions as an interface for data communications with the PC 3. The communications interface 24 has a function that supports a communications system using wired connection via a USB. Alternatively, for wireless connection with the PC 3, the communications interface 24 has a function that supports a communications system in Bluetooth (registered trademark) or a similar protocol.

The image capturing unit 27 includes a CCD image sensor or a CMOS image sensor. The image capturing unit 27 captures an image of an object and a scene at a position facing the image capturing unit 27 as a facing object.

The control unit 200 includes a controller 201, the detecting unit 202, the transmission controller 203, the display controller 204, the instruction accepting unit 205, and the communications controller 206.

The controller 201 manages an entire operation control of the portable terminal device 2. The controller 201 controls operations of the operation unit 21, the memory 22, the display unit 23, the communications interface 24, and the image capturing unit 27.

The detecting unit 202 detects a moving direction and an amount of movement of the portable terminal device 2 based on the image including reflected light captured by the image capturing unit 27. For example, a surface 20 (FIG. 1) on a side where the image capturing unit 27 of the portable terminal device 2 is installed is opposed to a surface of a desk, and the image capturing unit 27 captures an image with the portable terminal device 2 placed on the desk. Then, the image capturing unit 27 reads the opposed image of the desk surface part in a photographing region. The detecting unit 202 holds a pattern of the read image. The detecting unit 202 keeps capturing how the image part same as the image to be read thereafter moves in an x-axis direction and a y-axis direction. Thus, the detecting unit 202 calculates the moving direction and the amount of movement of the portable terminal device 2 in the x-axis direction and the y-axis direction.

The transmission controller 203 transmits movement information indicative of the moving direction and the amount of movement, which are detected by the detecting unit 202, to the PC 3. The transmission controller 203 further transmits instructions through the click operation and the scroll operation, which will be described later, accepted by the instruction accepting unit 205 to the PC 3.

The display controller 204 manages controls of a display and an operation by the display unit 23. The display controller 204 causes the display unit 23 to display the respective images for accepting instruction, which are to accept the instructions by the operator through the click operation and the scroll operation.

When the contact position by the operator at the display region on the display unit 23, which is detected by the touch panel, is a display part as any of the image for accepting right-click instruction, image for accepting left-click instruction, or image for accepting scroll instruction at the display region, the instruction accepting unit 205 accepts an input of the instruction corresponding to the image for accepting instruction displayed at this contact position.

The communications controller 206 performs a control required for communications with the PC 3 via the communications interface (interface unit) 24. When establishing the communications with the PC 3 via the communications interface 24, the communications controller 206 transmits a start instruction of an information accepting program, which will be described later, to the PC 3. The PC 3 starts an information receiving unit 302 and an information accepting unit 303.

The controller 201 may also serve as the transmission controller 203, the display controller 204, and the communications controller 206. In this case, the control unit 200 functions as the controller 201 by an operation in accordance with the information input program. Therefore, the independent transmission controller 203, display controller 204, and communications controller 206 are unnecessary.

The above-described information input program operates in corporation with an information accepting program, which will be described later, installed on the PC 3. Accordingly, the PC 3 can perform a reception process, an input acceptance process, or a similar process of an instruction transmitted from the transmission controller 203 of the portable terminal device 2 to the PC 3.

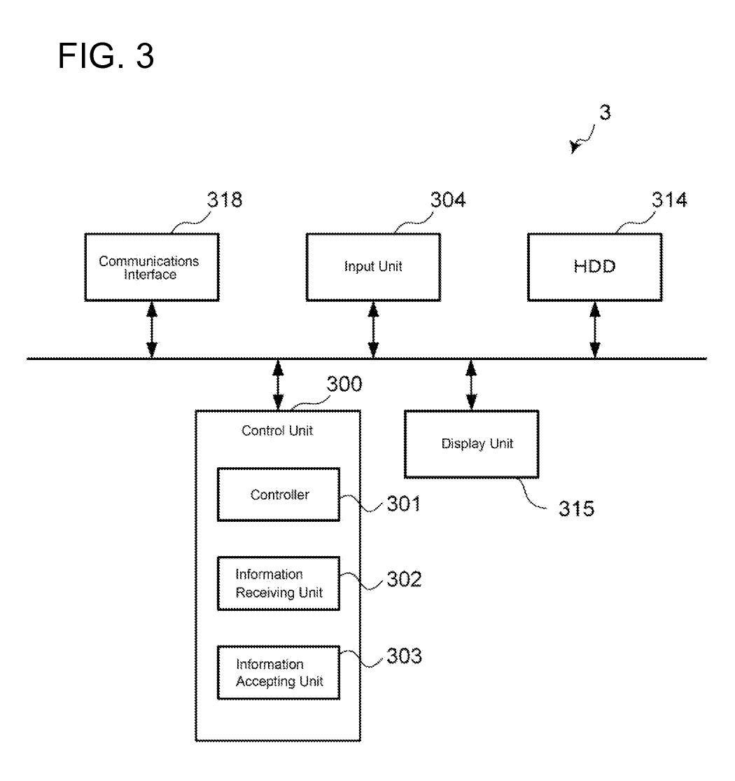

The following describes an outline of the constitution of the PC 3. FIG. 3 is a block diagram schematically illustrating the constitution of the PC 3.

The PC 3 includes a control unit 300, an HDD 314, a display unit 315, a communications interface 318, and an input unit 304. These respective units can mutually exchange data or a signal via a bus.

The control unit 300 is constituted of a CPU and similar members that include ROM and RAM. The control unit 300 manages an entire operation control of the PC 3.

The HDD 314 stores data of various application programs or a similar program. For example, the HDD 314 stores the information accepting program according to one embodiment of the disclosure.

The display unit 315 is constituted of a Liquid Crystal Display (LCD) or a similar display. The display unit 315 displays various images. For example, under the control by the controller 301, the display unit 315 displays an image of an application program stored on the HDD 314, for example, an Operating System (OS), a word processor, and a spreadsheet program in execution.

The communications interface 318 functions as an interface for data communications with the portable terminal device 2. The communications interface 318 has a function that supports wired connection via the USB cable or, for wireless connection, a function that supports Bluetooth (registered trademark) or a similar protocol.

The input unit 304 includes a keyboard, a mouse pointer, or a similar member. The input unit 304 accepts inputs of an operation instruction, a text, or similar data from the operator.

The control unit 300 includes a controller 301, the information receiving unit 302, and the information accepting unit 303.

When the control unit 300 operates in accordance with the information accepting program stored in an HDD 314, the control unit 300 functions as the information receiving unit 302 and the information accepting unit 303. However, these information receiving unit 302 and information accepting unit 303 may be constituted of respective hardware circuits independent of an operation based on the information input program.

The controller 301 manages an entire operation control of the PC 3.

The information receiving unit 302 receives various information transmitted from the transmission controller 203 of the portable terminal device 2, for example, the movement information, a right-click operation instruction, a left-click operation instruction, a scroll operation instruction, or a similar instruction.

The information accepting unit 303 accepts the moving direction and the amount of movement indicated by the movement information, which is received by the information receiving unit 302, as the moving direction and the amount of movement in which a cursor image as a cursor of the mouse pointer moves. The cursor is displayed on the display unit 315 of the PC 3 by the controller 301. The information accepting unit 303 accepts the right-click operation instruction, the left-click operation instruction, and the scroll operation instruction, which are received by the information receiving unit 302, as instructions executed by the application program.

As described above, the information accepting program of the PC 3 operates in corporation with the information input program on the portable terminal device 2 side. This ensures the reception process, the input acceptance process, or a similar process of the movement information, the click operation instruction, the scroll operation instruction, or a similar instruction, which is transmitted from the portable terminal device 2.

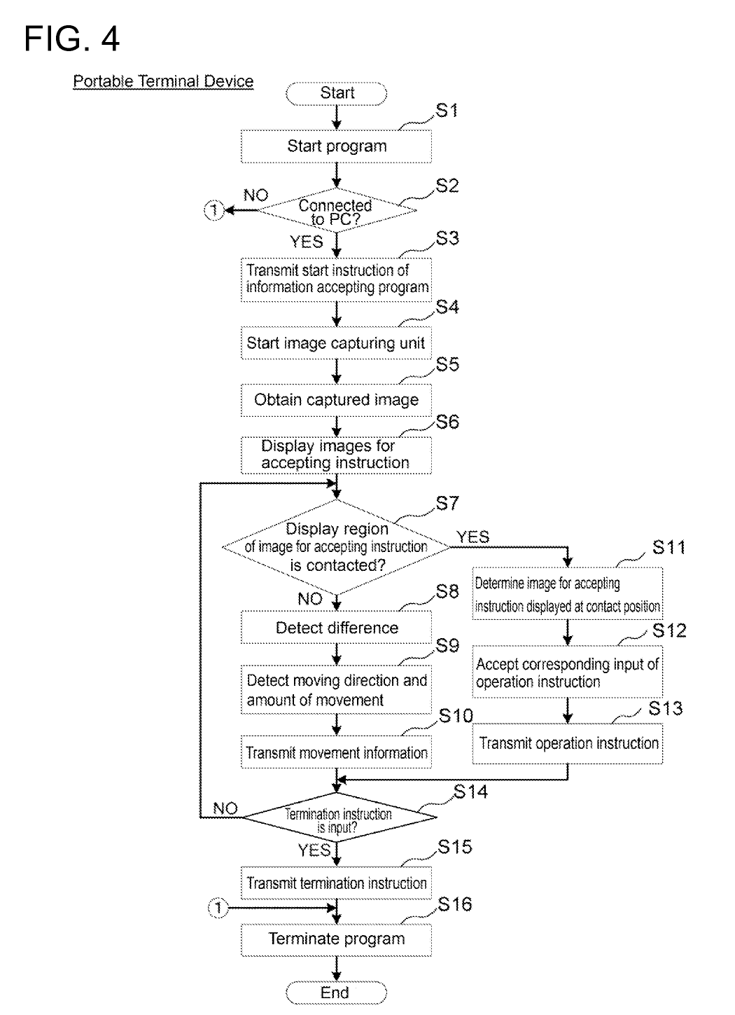

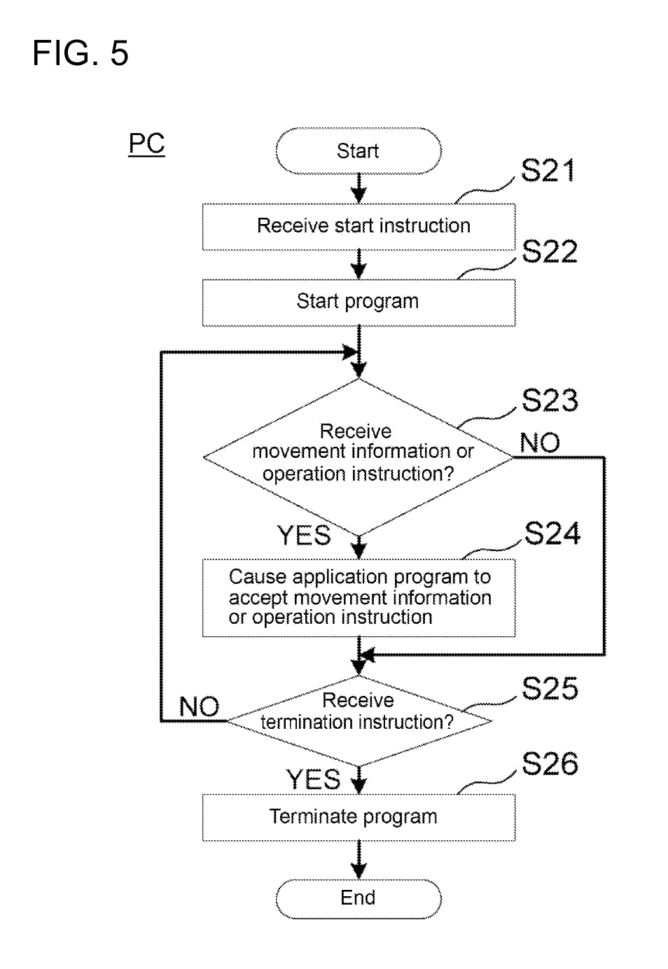

The following describes a first embodiment of the information input process by the information input system 1. FIG. 4 is a flowchart illustrating a flow of processes of the information input process by the portable terminal device 2 in the information input system 1 according to the first embodiment. FIG. 5 is a flowchart illustrating a flow of processes of the information input process by the PC 3 in the information input system 1 according to the first embodiment. It is assumed that the portable terminal device 2 of the information input system 1 is, as shown in the above as an example, placed on the surface of the desk making the surface 20 where the image capturing unit 27 is arranged opposed to the desk.

In the portable terminal device 2, when the operator operates the operation unit 21 to input the start instruction of the information input program, the control unit 200 starts the information input program (Step S1). The control unit 200 functions as the detecting unit 202, the transmission controller 203, the display controller 204, the instruction accepting unit 205, and the communications controller 206.

After this, the communications controller 206 detects whether the portable terminal device 2 is connected to the PC 3 via the communications interface 24 or not (Step S2). When the communications controller 206 detects the connection of the portable terminal device 2 to the PC 3 (YES at Step S2), the communications controller 206 transmits the start instruction of the information accepting program on the PC 3 side to the PC 3 (Step S3). If the communications controller 206 detects that the portable terminal device 2 is not connected to the PC 3 (NO at Step S2), the process is terminated.

At S1, instead of the start instruction from the operator, when the controller 201 detects the connection of the portable terminal device 2 to the PC 3, this may be regarded as the start instruction and then the information accepting program may be started. In this case, after starting the information input program, the communications controller 206 instantly transmits the above-described start instruction of the information accepting program to the PC 3.

On the PC 3, when the communications interface 318 receives the start instruction (Step S21), the controller 301 starts the information accepting program (Step S22).

On the other hand, at the portable terminal device 2, after the transmission of the start instruction of the information accepting program, the transmission controller 203 starts the image capturing unit 27 (Step S4). Accordingly, the image capturing unit 27 starts obtaining a captured image (Step S5). The display controller 204 causes the display unit 23 to display the image for accepting right-click instruction, image for accepting left-click instruction, and image for accepting scroll instruction (Step S6). At this time, the function of the touch panel ensures detection of a coordinate position contacted by the operator on the display unit 23 (Step S7).

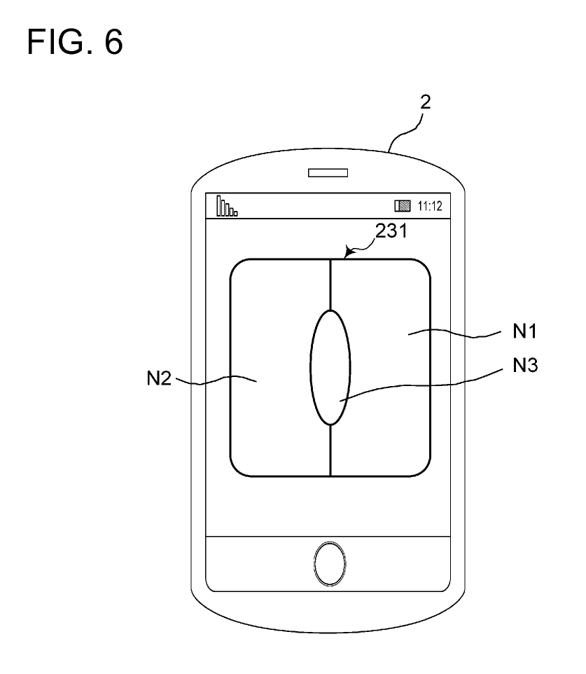

FIG. 6 illustrates an example where the image for accepting instruction is displayed on the display unit 23 of the portable terminal device 2. An image for accepting instruction 231 displayed on the display unit 23 includes an image for accepting right-click instruction N1, an image for accepting left-click instruction N2, and an image for accepting scroll instruction N3. The right-click operation instruction is made correspond to the image for accepting right-click instruction N1, the left-click operation instruction is made correspond to the image for accepting left-click instruction N2, and a scroll instruction is made correspond to the image for accepting scroll instruction N3. The instruction accepting unit 205 holds these correspondences of the instructions corresponding to the respective images N1 to N3 (stored in the memory 22 as a part of the information input program).

Here, when the operator slides and moves the portable terminal device 2 across the surface of the desk, the image capturing unit 27 sequentially captures different images as an elapse of time. The detecting unit 202 obtains this captured image. The detecting unit 202 detects a difference between the respective images obtained serially and continuously (NO at Steps S7 and S8). The detecting unit 202 detects the moving direction and the amount of movement of the portable terminal device 2 (Step S9). When the detecting unit 202 detects the moving direction and the amount of movement, the transmission controller 203 transmits these moving direction and amount of movement to the PC 3 as the movement information (Step S10).

When the function of the touch panel detects the coordinate position contacted by the operator on the display unit 23 (YES at Step S7), the instruction accepting unit 205 determines that the image for accepting instruction displayed at this detected coordinate position is any of the images N1 to N3 (Step S11). The instruction accepting unit 205 accepts the input of the operation instruction (any of the right-click operation instruction, the left-click operation instruction, and the scroll operation instruction) made correspond to this determined image for accepting instruction (Step S12).

If the contact position by the operator, which is detected with the touch panel, moves in a constant direction at a display part of the image for accepting scroll instruction in the display region, the instruction accepting unit 205 accepts the input of the instruction by the scroll operation.

Then, the transmission controller 203 transmits this accepted operation instruction to the PC 3 via the communications interface 24 (Step S13).

Until the operator inputs a termination instruction of the information input program by the operation of the operation unit 21 (NO at Step S14), the processes of Steps S7 to S13 are repeated.

On the PC 3, when the information receiving unit 302 receives the movement information or the operation instruction, which are transmitted from the portable terminal device 2, (YES at Step S23), the information accepting unit 303 accepts the moving direction and the amount of movement indicated by this received movement information or an instruction content indicated by the operation instruction (any of the right-click operation instruction, the left-click operation instruction, and the scroll operation instruction). The information accepting unit 303 causes an application program launched at this point (for example, the Operating System (OS), the word processor, and the spreadsheet program) to accept the instruction as an instruction to be input to this application program (Step S24). For example, the information accepting unit 303 functions as a mouse driver to this application program. The information accepting unit 303 performs a process such that the application program accepts the moving direction and the amount of movement, which are indicated by the received movement information, or the instruction content, which is indicated by the operation instruction, transmitted from the portable terminal device 2 similarly to the movement information, and the operation instruction input from the mouse pointer. This application program or the controller 301 moves and displays an image indicative of the mouse cursor based on these instructions.

In a state where the information receiving unit 302 does not receive the movement information or the operation instruction, which are transmitted from the portable terminal device 2 (NO at Step S23), a process of Step S25, which will be described later, is performed.

When the operator inputs the termination instruction of the information input program on the portable terminal device 2 (YES at Step S14), the communications controller 206 transmits the termination instruction to terminate the information accepting program on the PC 3 side to the PC 3 via the communications interface 24 (Step S15). After that, the control unit 200 terminates the information input program (Step S16).

Until the communications interface 318 receives the termination instruction (NO at Step S25), the PC 3 continues the processes of Steps S23 and S24. When the communications interface 318 receives the termination instruction (YES at Step S25), the control unit 300 terminates the information accepting program (Step S26).

According to the first embodiment, the portable terminal device 2 connected to the PC 3 can function as the mouse pointer of this PC 3. Accordingly, the operator can input an instruction to be input through the mouse pointer to the PC 3 using the portable terminal device 2 even if not possessing the mouse pointer.

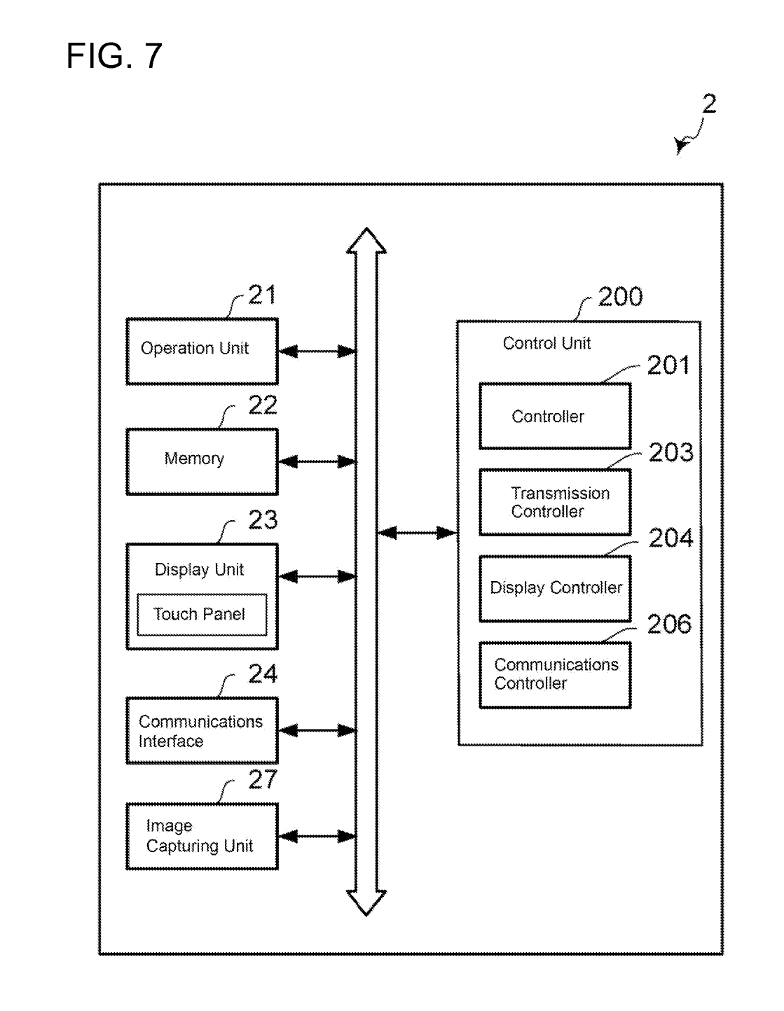

The following describes a second embodiment of the portable terminal device 2. FIG. 7 is a block diagram schematically illustrating the constitution of the portable terminal device 2 according to the second embodiment. The description of the constitution similar to the first embodiment, which is described using FIG. 2, is omitted.

When the control unit 200 operates in accordance with the image transmission program stored in the memory 22, the control unit 200 functions as the transmission controller 203 and the communications controller 206. However, these transmission controller 203 and communications controller 206 of the control unit 200 may be constituted of respective hardware circuits independent of an operation based on the image transmission program.

The controller 201 operates and controls the image capturing unit 27 to capture an image of a photographic subject.

The transmission controller 203 transmits the captured image, which is captured by the image capturing unit 27, to the PC 3 via the communications interface 24.

The communications controller 206 performs a control required for communications with the PC 3 via the communications interface (interface unit) 24.

The PC 3 that receives the captured image transmitted from the portable terminal device 2 according to the second embodiment has a constitution similar to the constitution illustrated in FIG. 3. On this PC 3, the operation in accordance with an image receiving program stored in the HDD 314 causes the control unit 300 to function as the information receiving unit 302 and the information accepting unit 303. However, the information receiving unit 302 and the information accepting unit 303 of the control unit 300 may be constituted of respective hardware circuits independent of an operation based on the image receiving program.

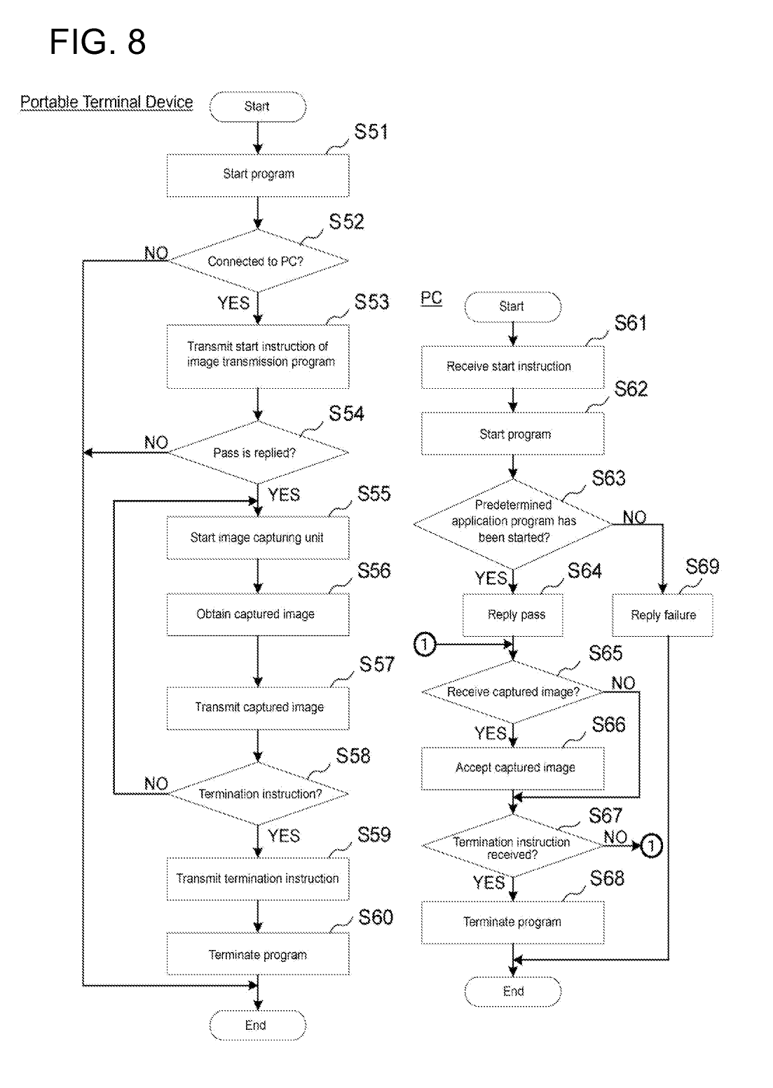

FIG. 8 is a flowchart illustrating a flow of processes in the image capturing input process by the information input system 1 that includes the portable terminal device 2 and the PC 3 according to the second embodiment. The processes illustrated in FIG. 8 and similar to the processes described using FIG. 4 and FIG. 5 will not be further elaborated here.

In the portable terminal device 2, when the operator operates the operation unit 21 to input the start instruction of the image transmission program, the control unit 200 starts the image transmission program (Step S51). The control unit 200 functions as the controller 201 and the communications controller 206.

After this, the communications controller 206 detects whether the portable terminal device 2 is connected to the PC 3 via the communications interface 24 or not (Step S52). When the communications controller 206 detects the connection of the portable terminal device 2 to the PC 3 (YES at Step S52), the communications controller 206 transmits the start instruction of the image receiving program on the PC 3 side to the PC 3 (Step S53). If the communications controller 206 detects that the portable terminal device 2 is not connected to the PC 3 (NO at Step S52), the process is terminated.

On the PC 3, when the communications interface 318 receives the start instruction (Step S61), the controller 301 starts the image receiving program (Step S62). Here, the information receiving unit 302 detects whether a predetermined application program (for example, an Internet calling software and a teleconference software) has been started or not (Step S63). The predetermined application program accepts the captured image transmitted from the portable terminal device 2.

When the information receiving unit 302 detects that the predetermined application program has been started (YES at Step S63), the information receiving unit 302 replies a “pass” signal (Step S64) via the communications interface 318. The “pass” signal indicates that this application program has been started and the captured image can be accepted from the portable terminal device 2.

If the information receiving unit 302 detects that the predetermined application program has not been started (NO at Step S63), the communications controller 206 transmits a “failure” signal via the communications interface 318 (Step S69). The “failure” signal indicates that this application program has not been started, and therefore text information cannot be accepted from the portable terminal device 2.

On the other hand, at the portable terminal device 2, when the communications controller 206 receives the “pass” signal via the communications interface 24 (YES at Step S54), the controller 201 starts the image capturing unit 27 (Step S55). When the image capturing unit 27 sequentially captures the photographic subject as the elapse of time (Step S56), the transmission controller 203 transmits this captured image to the PC 3 via the communications interface 24 (Step S57). Until the operator inputs a termination instruction of the image transmission program by the operation of the operation unit 21 (NO at Step S58), the processes of Steps S55 to S57 are repeated.

On the PC 3, when the information receiving unit 302 receives the captured image transmitted from the portable terminal device 2 (YES at Step S65), the information accepting unit 303 causes the predetermined application program launched at this point, for example, the Internet calling software and the teleconference software, to accept the received captured image as a captured image employed by this application program (Step S66). For example, the information accepting unit 303 performs a process of causing the Internet calling software and the teleconference software to accept the captured image as an image to be transmitted to a communication destination.

If the information receiving unit 302 does not receive the captured image, which is transmitted from the portable terminal device 2 (NO at Step S65), a process of Step S67, which will be described later, is performed.

At the portable terminal device 2, when the operator inputs the termination instruction of an image transmission program (YES at Step S58), the communications controller 206 transmits the termination instruction to terminate the image receiving program to the PC 3 via the communications interface 24 (Step S59). After this, the control unit 200 terminates the image transmission program (Step S60).

Until the communications interface 318 receives the termination instruction (NO at Step S67), the PC 3 continues the processes of Steps S65 and S66. When the communications interface 318 receives the termination instruction (YES at Step S67), the control unit 300 terminates the information accepting program (Step S68).

According to the second embodiment, the portable terminal device 2 connected to the PC 3 can be functioned as a camera of this PC 3. Accordingly, even if the PC 3 does not have a camera function, the portable terminal device 2 inputs an image similar to the captured image input by the camera to the PC 3. This ensures the use of the image in the application program such as the Internet calling software and the teleconference software.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An information input system comprising:
a computer and;
a portable terminal device; wherein
the portable terminal device includes
an image capturing unit that captures an image of a facing object,
a detecting unit that detects a moving direction and an amount of movement of the portable terminal device based on a captured image captured by the image capturing unit, and
a transmission controller that transmits movement information indicative of the moving direction and the amount of movement detected by the detecting unit to the computer, and
the computer includes
an information receiving unit that receives the movement information, the movement information being transmitted from the transmission controller of the portable terminal device; and
an information accepting unit that accepts the moving direction and the amount of movement indicated by the movement information received by the information receiving unit as a moving direction and an amount of movement in which a cursor moves, the cursor functioning in an application program operated on the computer.

2. The information input system according to claim 1, wherein:
the portable terminal device includes
a display unit that has a touch panel, the display unit ensuring image display,
a display controller that causes the display unit to display an image for accepting instruction, the image for accepting instruction causing the touch panel to accept an instruction by a click operation from an operator, and
an instruction accepting unit that accepts an input of the instruction by the click operation when a contact position by the operator detected with the touch panel in the display region is a display part of the image for accepting instruction in the contact position;
the transmission controller further transmits the instruction by the click operation accepted by the instruction accepting unit to the computer; and
at the computer,
the information receiving unit further receives the instruction by the click operation transmitted from the portable terminal device, and
the information accepting unit accepts the instruction by the click operation received by the information receiving unit as an instruction to be executed at a position indicated by the cursor in the application program.

3. The information input system according to claim 2, wherein
at the portable terminal device,
the display controller causes the display unit to further display an image for accepting instruction, the image for accepting instruction accepting an instruction by a scroll operation from an operator,
if a contact position by the operator detected with the touch panel moves in a constant direction at a display part of the image for accepting instruction in the display region, the instruction accepting unit accepts an input of an instruction by the scroll operation, and
the transmission controller further transmits the instruction by the scroll operation accepted by the instruction accepting unit to the computer; and
at the computer,
the information receiving unit further receives the instruction by the scroll operation transmitted from the portable terminal device, and
the information accepting unit accepts the instruction by the scroll operation received by the information receiving unit as an instruction to be executed in the application program.

4. An information input system comprising:
a computer and;
a portable terminal device; wherein
the portable terminal device includes
an image capturing unit that captures an image of a photographic subject, and
a transmission controller that transmits a captured image captured by the image capturing unit to the computer; and
the computer includes
an information receiving unit that receives the captured image information, the captured image information being transmitted from the transmission controller of the portable terminal device, and
an information accepting unit that accepts the captured image received by the information receiving unit as an image used in a predetermined application program operated on the computer.

5. The information input system according to claim 1, wherein the portable terminal device further includes:
an interface unit that communicates with and is connected to the computer; and
a communications controller that causes the information receiving unit and the information accepting unit to start on the computer when communication is established with the computer by the interface unit.

6. The information input system according to claim 5, wherein:
the interface unit communicates with the computer via a cable connected to the computer; and
the communications controller causes the information receiving unit and the information accepting unit to start on the computer when the cable is connected to the interface unit and communication is established with the computer.

7. The information input system according to claim 5, wherein:
the interface unit communicates with the computer by wireless communications; and
when wireless communication is established between the interface unit and the computer, the communications controller causes the information receiving unit and the information accepting unit to start on the computer.

8. A computer communicable with a portable terminal device, comprising:
an information receiving unit that receives movement information, the movement information being transmitted from the transmission controller of the portable terminal device; and
an information accepting unit that accepts a moving direction and an amount of movement indicated by the movement information received by the information receiving unit as a moving direction and an amount of movement in which a cursor moves.
